(19) United States
(12) Patent Application Publication
(10) Pub. No.: US 2017/0038952 A1
(43) Pub. Date: Feb. 9, 2017

(54) COMPUTER-READABLE RECORDING MEDIUMS, AND INFORMATION PROCESSING APPARATUS

(71) Applicants: FUJITSU LIMITED, Kawasaki-shi (JP); NATIONAL UNIVERSITY CORPORATION KAGAWA UNIVERSITY, Takamatsu-shi (JP)

(72) Inventors: Ken Suginome, Kawasaki (JP); Satoshi Sakai, Takamatsu (JP); Eiichi Miyazaki, Takamatsu (JP)

(21) Appl. No.: 15/222,318

(22) Filed: Jul. 28, 2016

(30) Foreign Application Priority Data
Aug. 7, 2015 (JP) 2015-157722

(51) Int. Cl. G06F 3/0484; G09B 19/00; G06T 7/00; G09B 5/12; G06F 3/0482; G06T 13/80

(52) U.S. Cl. CPC G06F 3/04845; G06F 3/0482; G06T 13/80; G06T 7/0024; G09B 5/125; G09B 19/00

(57) ABSTRACT

A computer-readable recording medium stores therein an essay creation supporting program that causes a computer to execute a process including: displaying a first screen that includes an object related to one particular affair serving as an essay target and includes a predetermined item related to the one particular affair; receiving, in the first screen being displayed, an instruction operation regarding the predetermined item; and displaying that includes sliding in a second screen, in which a plurality of options regarding a predetermined item corresponding to the received instruction operation is indicated in a selection-input-receivable manner, for display in a screen in which the first screen is displayed, and displaying, on a continuing basis on the screen, the object, which is displayed in the first screen, even during the sliding in and after completion of the sliding in.

### CROSS-REFERENCE TO RELATED APPLICATION(S)

This application is based upon and claims the benefit of priority of the prior Japanese Patent Application No. 2015-157722, filed on Aug. 7, 2015, the entire contents of which are incorporated herein by reference.

### FIELD

The embodiment discussed herein is related to computer-readable recording mediums, and information processing apparatus.

### BACKGROUND

With the use of tablet terminals, next-generation type classes are being conducted. In a next-generation type class, as an example, essay creation is undertaken as an exercise for thinking about one's own feelings and conveying them. In that regard, a conventional technology for essay creation is known that, during essay creation, enables selection of a single topic and outputs an advice sheet in which advice information for writing an essay on the selected topic is written.

Patent Literature 1: Japanese Laid-open Patent Publication No. 2001-273373

However, in the conventional technology mentioned above, during essay creation, it is difficult to support continuous thinking about one particular affair.

For example, the students taking a next-generation type class may include a student who has difficulty with short-term memory. Such a student having difficulty with short-term memory is sometimes not good at comprehending the cause-effect relationship, and thus may forget the affair considered as the topic (called the main subject) of the essay during essay creation. Hence, completing the essay becomes a difficult task; and the objective of essay creation, which is to think about one's own feelings and convey them, sometimes cannot be achieved.

### SUMMARY

According to an aspect of an embodiment, a computer-readable recording medium stores therein an essay creation supporting program that causes a computer to execute a process including: displaying a first screen that includes an object related to one particular affair serving as an essay target and includes a predetermined item related to the one particular affair; receiving, in the first screen being displayed, an instruction operation regarding the predetermined, item; and displaying that includes sliding in a second screen, in which a plurality of options regarding a predetermined item corresponding to the received instruction operation is indicated in a selection-input-receivable manner, for display in a screen in which the first screen is displayed, and displaying, on a continuing basis on the screen, the object, which is displayed in the first screen, even during the sliding in and after completion of the sliding in.

The object and advantages of the invention will be realized and attained by means of the elements and comsbinations particularly pointed out in the claims.

It is to be understood that both the foregoing general description and the following detailed description are exemplary and explanatory and are not restrictive of the invention, as claimed.

### BRIEF DESCRIPT10N OF DRAWINGS

FIG. 1 is a diagram illustrating an essay creation supporting system according to an embodiment;

FIG. 2 is a block diagram illustrating a configuration example of a student terminal;

FIG. 3 is a flowchart for explaining an example of operations performed by the student terminal;

FIG. 4 is an explanatory diagram for explaining display screens on the student terminal;

FIG. 5 is a flowchart for explaining an example of a slide-in operation;

FIG. 6 is an explanatory diagram for explaining the sliding in of a sub-screen;

FIG. 7 is an explanation diagram for explaining a main screen and sub-screens;

FIG. 8 is a flowchart for explaining an example of a slide-out operation;

FIG. 9 is an explanatory diagram for explaining a slide-out operation with respect to a sub-screen;

FIG. 10 is an explanatory diagram for explaining the sliding out of a sub-screen;

FIG. 11 is a flowchart for explaining an example of a preview screen display operation;

FIG. 12 is an explanatory diagram for explaining the display of a preview screen;

FIG. 13 is an explanatory diagram for explaining a modification example of providing input support; and

FIG. 14 is an explanatory diagram for explaining an example of a computer that executes a computer program.

### DESCRIPTION OF EMBODIMENT(S)

Preferred embodiments of the present invention will be explained with reference to accompanying drawings.

In the embodiments, the constituent elements having identical functions ars referred to by the same reference numerals, arid the redundant explanation is not repeated. Meanwhile, the computer-readable recording mediums, the essay creation supporting method, the input supporting method, and the information processing apparatus invention are not limited by the embodiments described herein. Moreover, the embodiments can be appropriately combined without causing contradiction in the processing details.

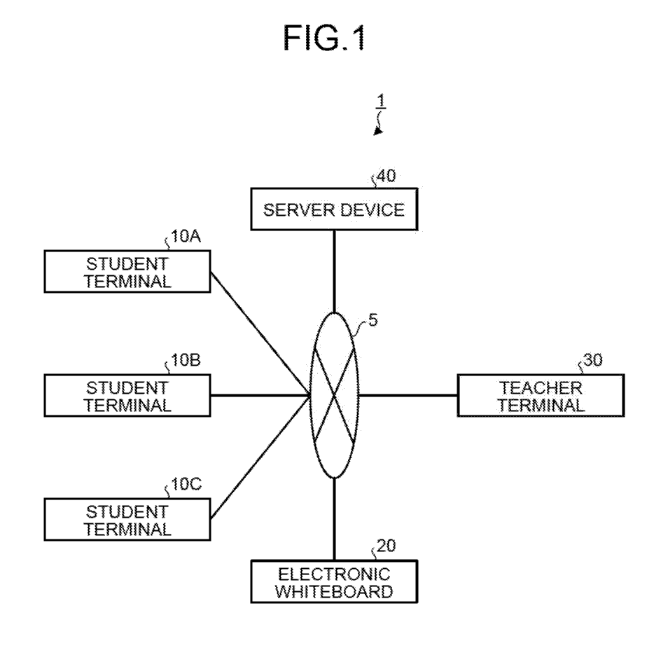

FIG. 1 is a diagram illustrating an essay creation supporting system 1 according to the embodiment. The essay creation supporting system 1 represents an exemplary form of a system for supporting next-generation type classes, and represents an example of a system that enables students to create essays.

As illustrated in FIG. 1, the essay creation supporting system 1 houses student terminals 10A to 10C, an electronic whiteboard 20, a teacher terminal 30, and a server device 40. Meanwhile, in FIG. 1, although three student terminals 10A to 10C are illustrated, the essay creation supporting system 1 can house an arbitrary number of student terminals. In the following explanation, when the student terminals 10A to 10C need not be distinguished from each other, they are referred to as the “student terminal 10”.

The student terminal 10, the electronic whiteboard 20, the teacher terminal 30, and the server device 40 are communicably connected to each other via a network 5. As far as the network 5 is concerned; regardless of whether wired or wireless, it is possible to implement an arbitrary type of network such as a private communication network in the form of local area network (LAN), or a virtual private network (VPN), or another arbitrary type of communication network such as the Internet.

The student terminal 10 represents a terminal device used by a student. Herein, the term “student” points to a person who is a learner among the participants of a class. As an example, it is possible to consider various types of pupils. However, it is not necessary that a “student” is a pupil. Herein, for example, a student uses the student terminal 10; treats an image (affair) selected from among a plurality of images as the main subject (object); and creates an essay by setting various items with respect to the main subject.

Examples of the items with respect to the main subject of an essay include the five W's and one H, namely, who, what, when, where, why, and how. In the present embodiment, as an example of an essay, the explanation is given with reference to a daybook in which everyday affairs are written. As a result of malting a student to create a daybook on a daily basis, it becomes possible to do daily training of thinking about one's own feelings and conveying them.

Moreover, in the present embodiment, it is assumed that “feelings”, “who”, “when”, “where”, “with whom”, and “what” are provided in advance as the items for a daybook. The item “feelings” represents the item indicating the feelings of the concerned person. The item “who” represents the item indicating who did. The item “when” represents the item indicating the time of doing. The item “where” represents the item indicating the place of doing. The item “with whom” represents the item indicating the accompanying person at the time of doing. The item “what” represents the item indicating what was done. These items are only exemplary, and can be appropriately set by a teacher according to each student.

As one illustrative embodiment, in the student terminal 10, computer programs that are meant for student terminals (an essay creation supporting program and an input supporting program) and that enable essay creation are installed as package software or online software. When these computer programs are run in the processor of the student terminal 10, for example, the function of supporting essay creation by the student is implemented in the student terminal 10.

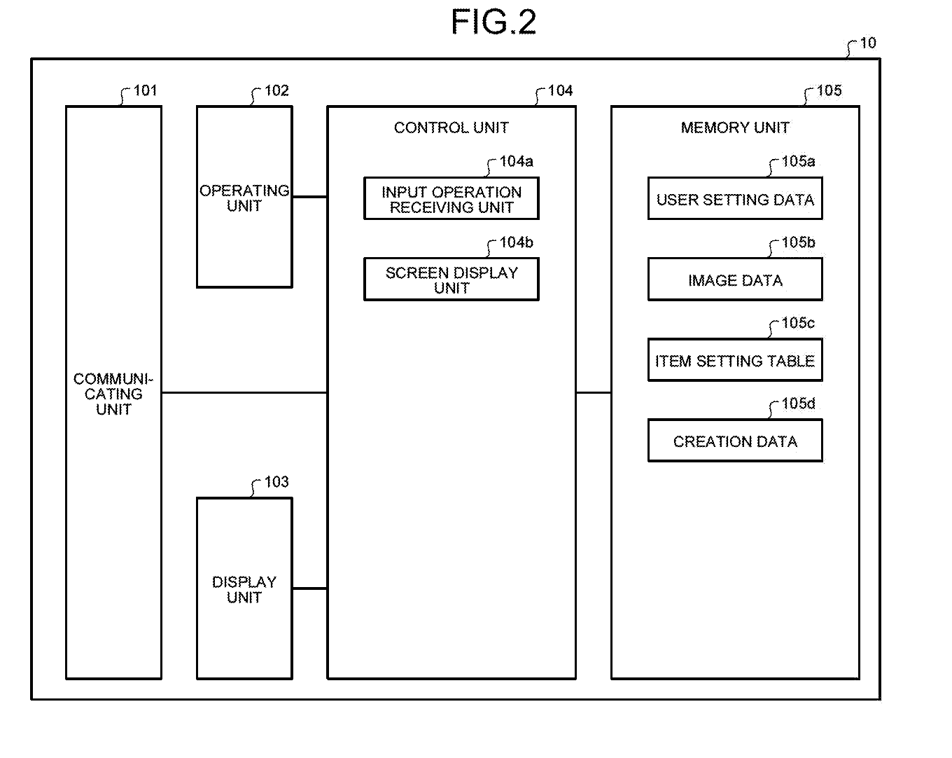

As far as the student terminal 10 is concerned, it is possible to use a tablet-type information, processing terminal, that is, a tablet terminal, for example. As a result of using a tablet terminal as the student terminal 10, it becomes possible for the student terminal 10 to receive various instruction operations via a stylus pen or a finger. Besides, the student terminal 10 can receive a handwritten input, such as a character string or a mark, on an operating unit 102 (see FIG. 2) such as a touch-sensitive panel.

The electronic whiteboard 20 is a device for displaying images that are output from a predetermined projector. As one illustrative embodiment, as far as the electronic whiteboard 20 is concerned, an interactive whiteboard can be used. To the electronic whiteboard 20, a projector (not illustrated) is connected. The projector projects, onto the electronic whiteboard 20, pictures instructed to be displayed by the teacher terminal 30. On the electronic whiteboard 20, not only it is possible to display images identical to the images displayed by the student terminal 10, but it is also possible to display different images. Moreover, it goes without saying that the electronic whiteboard 20 can be of any one of the following types: a unit, type, a board type, and an in tegrated type.

The teacher terminal 30 is a terminal device used by a teacher. Herein, the term “teacher” points to a person who doss teaching among the participants of a class. As an example, it is possible to consider various types of faculty members. However, it is not necessary that a “teacher” is a qualified person having various types of teacher certificates. Herein, for example, the teacher uses the teacher terminal 30 and checks the essays created using the student terminal 10.

As one illustrative embodiment, in the teacher terminal 30, a computer pro-gram meant for teacher terminals is installed as package software or online software. When that computer program is run in the processor of the teacher terminal 30, various functions such as the function of setting the student (user) who would use the student terminal 10 and the function of displaying essays created using the student terminal 10 on the electronic whiteboard 20 can be implemented.

For example, in an identical manner to the student terminal 10, it is possible to use a tablet terminal as the teacher terminal 30. As a result of using a tablet terminal as the teacher terminal 30, it becomes possible for the teacher terminal 30 to receive various instruction operations via a stylus pen or a finger.

The server device 40 is a server device of a client server system, that houses the student terminal 10, the electronic whiteboard 20, and the teacher terminal 30 as client terminals. As one illustrative embodiment, as far as the server device 40 is concerned, a personal computer or a workstation can be used. In the server device 40, a computer program for server devices is installed. When that computer program is run in the processor thereof, the server device 40 functions, for example, as a web server and provides various services to the client terminals such as the student terminal 10, the electronic whiteboard 20, and the teacher terminal 30. Moreover, for example, the server device 40 can provide the function of a file server that manages a variety of information about the student (user) who is using the student terminal 10, and manages the essays (essay data) created using the student terminal 10.

FIG. 2 is a block diagram illustrating a configuration example of the student terminal 10. Herein, the student terminal 10 is a tablet-type information processing terminal or a personal computer, and includes a communicating unit 101, the operating unit 102, a display unit 103, a control unit 104, and a memory unit 105.

The communicating unit 101 is an interface that, under the control of the control unit 104, performs communication with other devices connected via the network 5. The operating unit 102 is a device such as a keyboard, a mouse, or a touch-sensitive panel that receives an operation from the user and outputs the operation to the control unit 104. The display unit 103 is a device such as a liquid crystal display (LCD), and performs display under the control of the control unit 104.

The control unit 104 includes an internal memory for storing various computer programs and control data, and performs various operations using the computer programs and the control data. As one illustrative embodiment, the control unit 104 is implemented as a central processing unit (CPU). However, the control unit 104 need not always be implemented as a central processing unit, and alternatively can be implemented as a micro processing unit (MPU). Alternatively, the control unit 104 can be implemented using a hardware wired logic such as an application specific integrated circuit (ASIC) or a field programmable gate array (FPGA).

The control unit 104 runs computer programs and functions as an input operation receiving unit 104a and a screen display unit 104b. The input operation receiving unit 104a receives various instruction operations input by the user from the operating unit 102. For example, the input operation receiving unit 104a receives a selection operation with respect to the items displayed on the screen of the display unit 103, or receives instruction operations from, the user during essay creation. In the control unit 104, essay data is created based oh the instruction operations received by the screen display unit 104b from the user.

The screen display unit 104b creates display data and outputs it to the display unit 103 so as to display various screens on the display unit 103. For example, the screen display unit 104b displays, on the display unit 103, a creation screen (also called a main screen) enabling creation of an essay about one particular affair and screens (also called sub-screens) enabling input of the items accompanying the affair taken up in the essay. Moreover, the screen display unit 104b also performs switching between the main screen and the sub-screens. Regarding the display of screens performed by the screen display unit 104b during essay creation, the details are given later.

The memory unit 105 is a memory device used in storing the operating system (OS) run in the control unit 104, various computer programs for implementing the functions of the input operation receiving unit 104a and the screen display unit 104b, and data used in the various computer programs. As one illustrative embodiment, the memory unit 105 is implemented as the main memory device in a device. For example, as far as the memory unit 105 is concerned, it is possible to use various types of semiconductor memory elements such as a random access memory (RAM) and a flash memory. Alternatively, the memory unit 105 can be implemented as an auxiliary memory device. In that case, it is possible to use a hard disk drive (HDD), an optical disk, or a solid state drive (SSD). The memory unit 105 is used to store user setting data 105a, image data 105b, an item setting table 105c, and creation data 105d.

The user setting data 105a represents data indicating various settings regarding the user (student). For example, the user setting data 105a contains identification information (for example, a user ID) enabling identification of the user, user name, user-specific display settings, and user-specific operation settings. Meanwhile, the user setting data 105a can be set in accordance with the student by the teacher using the teacher terminal 30. The user setting data 105a set by the teacher using the teacher terminal 30 is, for example, stored in the server device 40 and, when the student terminal 10 performs user authentication, the user setting data 105a is read from the server device 40 and is stored in the memory unit 105.

The image data 105b represents data of various moving images or still, images used in essay creation. More particularly, the image data 105b represents image files of still images or moving images treated as the main subjects of essays, and image files of icon images used as the items of essays. Such image files can be stored in advance in the server device 40, and can then be read and stored in the memory unit 105.

The item setting table 105c represents a data file for storing item-by-item settings in an essay and is used to store item-by-item settings in a table format, for example. More particularly, in the item setting table 105c, various settings such as name, options, and display setting are stored for each of the item such as “feelings”, “who”, “when”, “where”, “with whom”, and “what” in an essay (a daybook).

The options are set in advance in the form of selectable entities in each item and content details expressing the entities in characters. For example, the item “feelings” includes the numerical range expressing the feeling (of happiness), images (such as emoticons) expressing the feelings corresponding to the numerical values, and corresponding content details ranging from “somewhat happy” to “very happy”. Moreover, the item “who” includes persons such as the concerned person himself or herself, nearest relatives, friends, and teachers; images (for example, emot icons) representing the persons; and content details such “sibling”, “friend”, and “teacher”. Furthermore, the item “when” includes a calendar for selecting the date and a clock for selecting the time. Moreover, the item “where” includes places such as the home, the school, a park; and images indicating the places and the corresponding content details. Furthermore, the item “with whom” includes persons, images representing the persons, and the corresponding content details in an identical manner to the item “who”. The item “what” includes action details such “played” or “studied” and images (for example, icons) representing the actions.

The display settings include, for example, the display position, the display color, the display shape, and the display size of each item. The student terminal 10 can refer to the display setting in the item setting table 105c and perform display corresponding to each item.

In an identical manner to the user setting data 105a, the item setting table 105c can represent data that is set according to the student by the teacher using the teacher terminal 30. The item setting table 105c set by the teacher using the teacher terminal 30 is, for example, stored in the server device 40 and, when the student terminal 10 performs user authentication, the item setting table 105c is read from the server device 40 and is stored in the memory unit 105.

The creation data 105d represents data of an essay created by the student by operating the student terminal 10. More particularly, the creation data 105d is used to store the image selected as the main subject from the image data 105b and information of the selection content from among the options for each item.

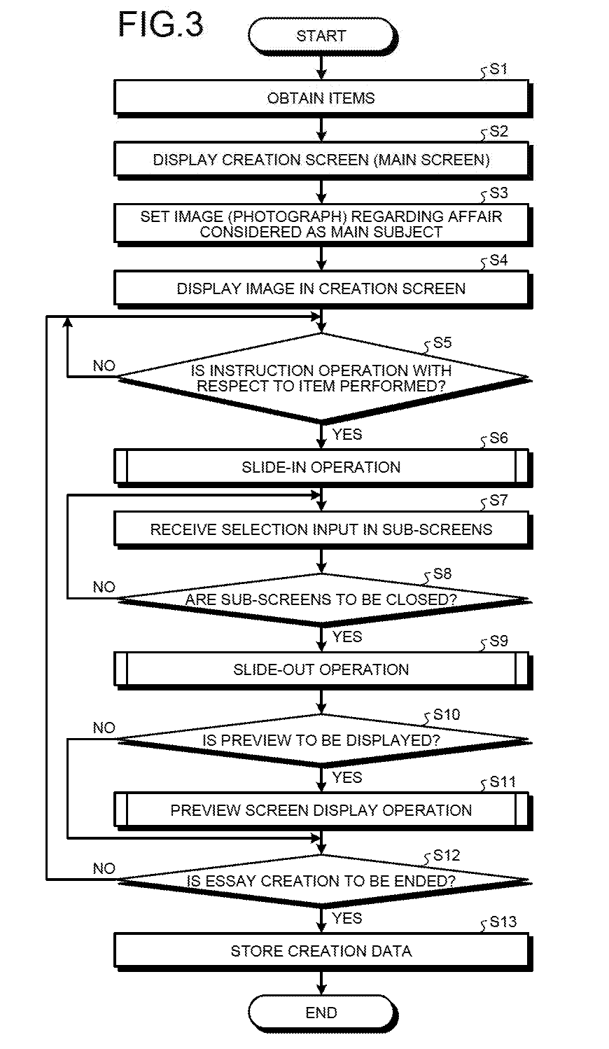

FIG. 3 is a flowchart for explaining an example of operations performed by the student terminal 10. More particularly, in FIG. 3 are illustrated the operations performed by the student terminal 10 during essay creation. As illustrated in FIG. 3, after the start of operations, the screen display unit 104b refers to the item setting table 105c and obtains the settings (the name, the option, and the display setting) of each item to be used in the essay (S1).

Then, based on the settings of each item as obtained at S1, the screen display unit 104b displays, on the display unit 103, a creation screen (a main screen) for creating an essay by placing the items in the essay (S2).

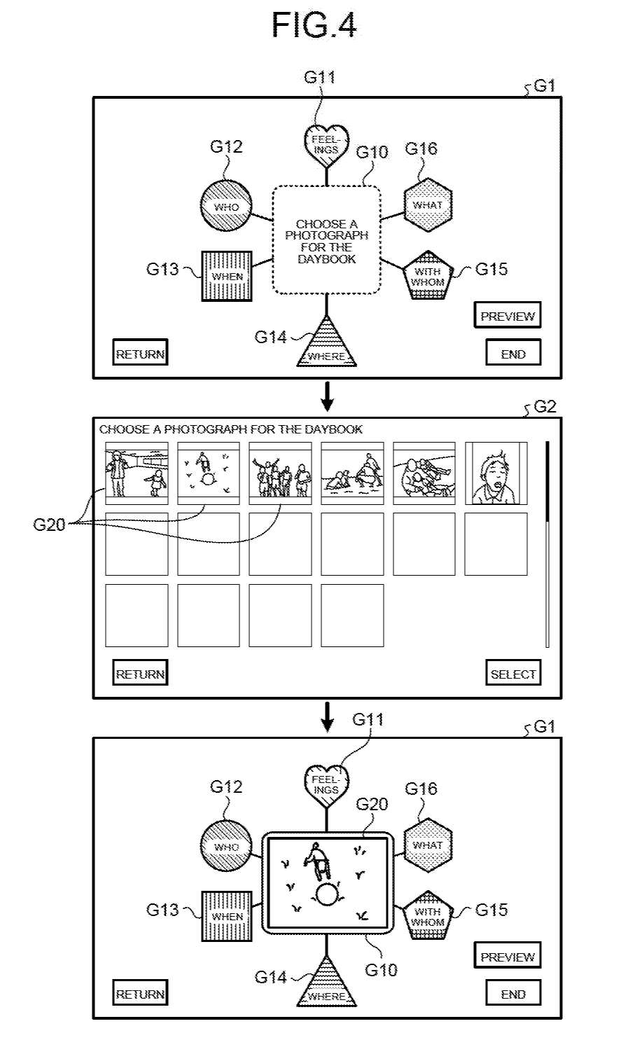

FIG. 4 is an explanatory diagram for explaining display screens on the student terminal 10. As illustrated in FIG. 4, in a main screen G1, essay-related items G11 to G16 are placed around a main, subject display area G10 that is used for displaying the main subject of the essay. Herein, around the main subject display area G10, the items G11 to G16 are placed with the display colors, the display shapes, and the display sizes set in the item setting table 105c.

Then, as a result of a touch operation with respect to the main subject display area G10, the input operation receiving unit 104a receives an instruction for setting (registering) an image G20 (a photograph) that represents the main subject of the essay. In response, to the instruction to set the image G20, the screen display unit 104b reads the image data 105b and displays, on the display unit 103, a photograph selection screen G2 having the images G20 arranged therein. As a result of a touch operation performed with respect to the images G20 arranged in the photograph selection screen G2, the input operation receiving unit 104a receives the setting (registration) of the image G20 to be considered as the main subject of the essay (S3).

Meanwhile, in the present embodiment, the explanation is given for a case in which a photograph is set as the image G20 to be considered as the main subject of the essay. However, the image G20 to be set is not limited to a photograph. Alternatively, for example, a moving image such as a video can also be set as the main subject of the essay.

Subsequently, the screen display unit 104b displays the image G20, which is set at S3, in the main subject display area G10 of the main screen G1 (S4). More particularly, as illustrated in FIG. 4, the image G20 that is selected by the user from among the images G20 arranged in the photograph selection screen G2 is displayed in the main subject display area G10 of the main screen G1.

Then, the input operation receiving unit 104a determines whether or not an instruction operation with respect to an item is performed in the form of a touch operation with respect to an item from among the items G11 to G16 displayed in the main screen G1 (S5). If the selection operation with respect to an item is not performed (NO at S5), the control unit 104 waits for the operation.

When the selection operation with respect to an item is performed (YES at S5), the screen display unit 104b performs a slide-in operation in which sub-screens to be used in setting the options for the concerned item, for which the selection operation was performed, are slid in and displayed at predetermined positions on the display screen of the display unit 103 (S6).

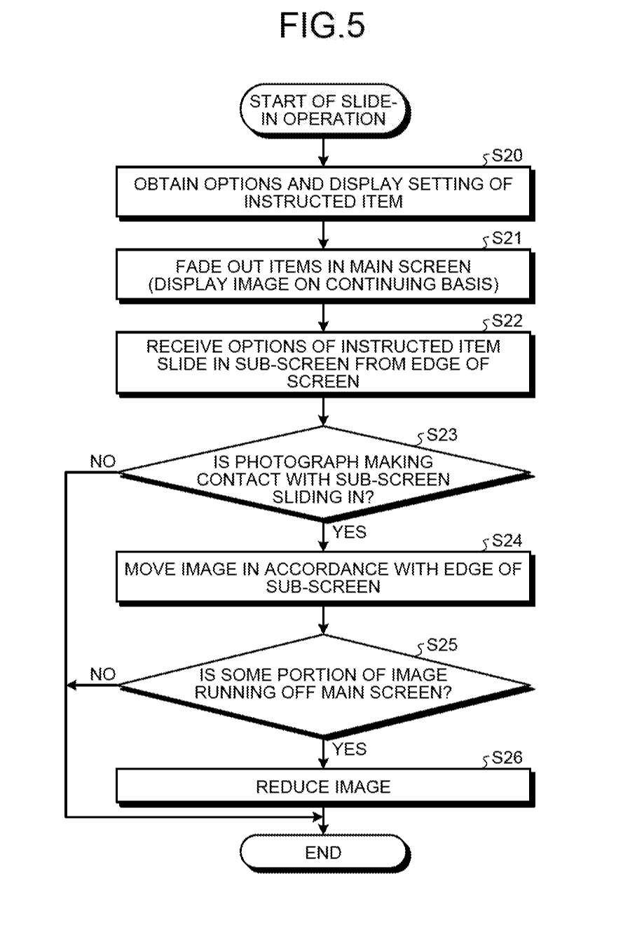

FIG. 5 is a flowchart for explaining an example of the slide-in operation. As illustrated in FIG. 5, after the start of operations, the screen display unit 104b obtains, from the item setting table 105c, the options and the display setting of the item for which the selectio operation was instructed (S20).

Then, the screen display unit 104b performs a fadeout operation in which the items G11 to G16 displayed in the main screen G1 are gradually faded out (by lowering the brightness, for example) (S21). At that time, the screen display unit 104b does not fade out the image G20, and displays the image G20 on a continuing basis in the main screen G1.

Subsequently, the screen display unit 104b performs a slide-in operation in which sub-screens to be used to receive the options of the concerned item, for which the selection operation was performed, are gradually moved (slid in) from an edge of the screen toward the center of the screen and are stopped at predetermined positions (S22).

At that time, the sub-screens are displayed according to the display setting obtained at S20. That is, the sub-screens are displayed in accordance with the display setting of the item for which the selection operation was instructed. As an example, the screen display unit 104b displays the sub-screens having the same display color as the display color of the item for which the selection operation was instructed.

Moreover, in the display screen of the display unit 103, the sub-screens can be positioned, at positions set in advance (for example, the portion occupying two-thirds of the screen). Alternatively, the positions of the sub-screens can be varied according to the number of options of the item, so that all items are displayed.

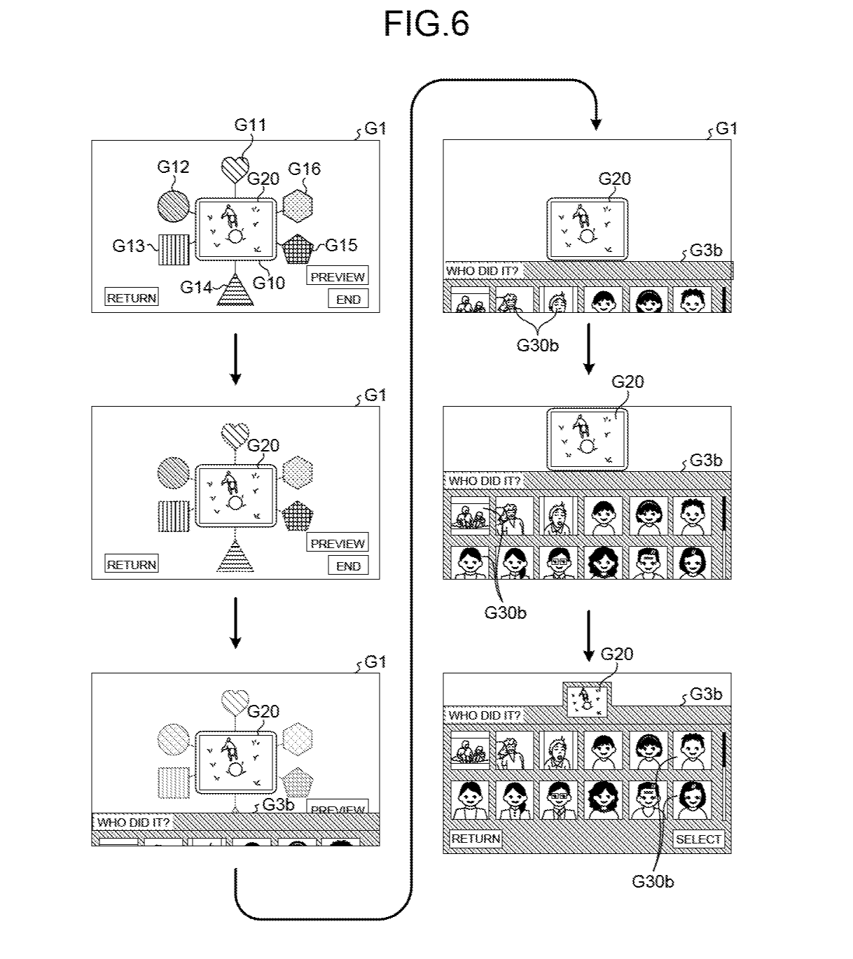

FIG. 6 is an explanatory diagram for explaining the sliding in of a sub-screen. In FIG. 6 is illustrated an example in which a selection operation is performed with respect to the item G12 (“who”).

As illustrated in FIG. 6, as a result of performing a selection operation with respect to the item G12, the items G11 to G16 fade out in the main screen G1. At that time, the image G20 is displayed on a continuing basis in the main screen G1 (refer to the middle screen on the left side in FIG. 6). In this way, by displaying the image G20 on a continuing basis, the student terminal 10 can prevent the user from forgetting about the image G20 representing the main subject of the essay.

Then, an animation display is performed in which a sub-screen G3b, which is used for receiving options G30b for the item G12, is gradually slid in from an end of the screen (the lower end of the screen) toward the center (in the upward direction) (refer to the lower screen on the left side and the upper screen on the right side in FIG. 6). The sub-screen G3b has the same display setting (for example, the same display color) as the item G12. Hence, the user can easily recognize the item details in the sub-screen G3b.

After the operation at S22, the screen display unit 104b determines whether or not the image G20 (a photograph) is making contact with an edge of the sub-screen being slid in (S23). If the image G20 is not making contact with an edge of the sub-screen (NO at S23), the screen display unit 104b continues to slide in the sub-screen up to a predetermined position and then stops the sub-screen. It marks the end of the operations.

When the image G20 makes contact with an edge of the sub-screen (YES at S23), the screen display unit 104b moves the image G20 in accordance with the edge of the sub-screen (S24). That is, the screen display unit 104b moves the display position of the image G20 in accordance with the sliding in of the sub-screen, so that the position of the image G20 keeps clear of the sub-screen.

For example, as illustrated from the lower screen on the left side to the middle screen on the right side in FIG. 6, when the image G20 is making contact with an edge of the sliding sub-screen G3b, the image G20 is moved upward in accordance with the edge of the sub-screen G3b. As a result, in the student terminal 10, the image G20 can be displayed on a continuing basis without resulting in overlapping with the sub-screen G3b.

Then, the screen display unit 104b moves the image G20 in accordance with the sliding in of the sub-screen, and determines whether or not some portion of the image G20 runs off the main screen G1 (S25). For example, while the image G20 is being moved in accordance with the sliding in of the sub-screen, when the rim of the image G20 makes contact with the screen edge of the main screen G1, the screen display unit 104b determines that some portion of the image G20 runs off the main screen G1.

When no portion of trie image G20 is running off the main screen G1 (NO at S25), the screen display unit 104b continues to slide in the sub-screen without changing the display size of the image G20 and then stops the sub-screen at a predetermined position. It marks the end of the operations.

When some portion of the image G20 runs off the main screen G1 (YES at S25), the screen display unit 104b reduces the image G20 in size so that it fits within the screen (S26).

For example, as illustrated in the lower screen on the right side in FIG. 6, the screen display unit 104b displays the image G20 in a reduced size. As a result, in the student terminal 10, even when there is an increase in the area occupied by the sub-screen G3b in the screen of the display unit 103, the entire image G20 can be displayed on a continuing basis.

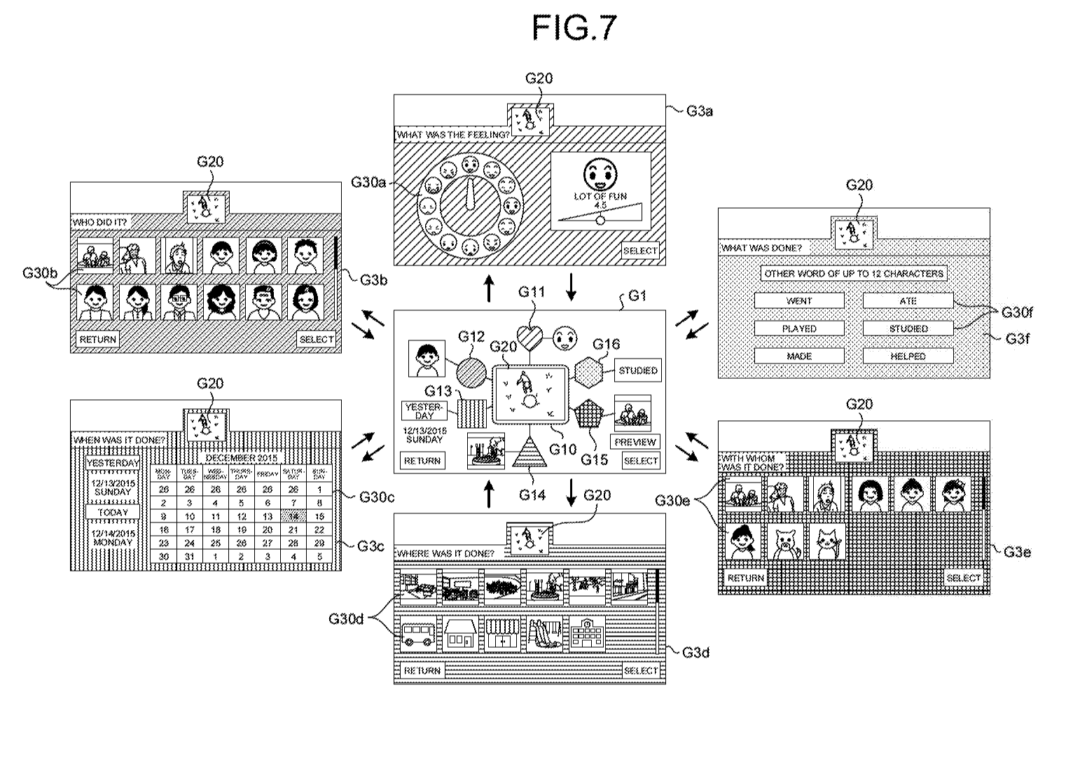

FIG. 7 is an explanation diagram for explaining the main screen G1 and sub-screens G3a to G3f. As illustrated in FIG. 7, as a result of performing selection operations with respect to the items G11 to G16 in the main screen G1, the sub-screens G3a to G3f corresponding to the items G11 to G16, respectively, are displayed on the display unit 103 in a sliding manner.

The user inputs the items G11 to G16 by performing an operation of specifying options G30a to G30f in the sub-screens G3a to G3f, respectively, using the operating unit 102. At the time of inputting the items G11 to G16, during the sliding in of the sub-screens G3a to G3f and after completion of the sliding in of the sub-screens G3a to G3f, the image G20 representing the main subject of the essay is displayed on a continuing basis in the student terminal 10. As a result, the student terminal 10 can prevent the user from forgetting about the image G20, which represents the main subject of the essay, while inputting the items G11 to G16 related to the main subject of the essay. As a result, the student terminal 10 can support the user to continuously think about one particular affair (main subject).

Meanwhile, regarding the sliding in of the sub-screens G3a to 63f, for example, an animation display is performed in which the sub-screens are gradually moved from the lower part of the screen toward the center of the screen (in the upward direction) and are stopped at predetermined positions on the screen. Herein, the direction of movement of the sub-screens during the sliding in and the positions at which the sub-screen are stopped are only exemplary. Alternatively, it is possible to have variations on an item-by-item basis, such as moving a sub-screen from the upper part of the screen in the downward direction.

Meanwhile, regarding the sliding in of the sub-screens at the time of switching from the main screen G1 to the sub-screens, as long as the image G20 is displayed on a continuing basis while the main screen G1 fades out and the sub-screens are displayed, the manner of display is not-limited to the animation format described above. Alternatively, for example, the sub-screens can be faded in. Moreover, for example, the size of the image G20 can be enlarged in accordance with the area of the screen occupied by the sub-screens.

Returning to the explanation with reference to FIG. 3, the input operation receiving unit 104a receives the selection input of options in the sub-screens that are slid in and displayed on the display unit 103 (S7). More particularly, the input operation receiving unit 104a receives the input of predetermined options as a result of touch operations with respect to the options arranged in the sub-screens.

Subsequently, the screen display unit 104b determines whether or not to close the sub-screens based on whether or not an operation instruction for closing the sub-screens is issued (S8). If the sub-screens are not to be closed (NO at S8), the system control returns to S7 and the screen display unit 104b continues to display the sub-screens.

When the screens are to be closed (YES at S8), the screen display unit 104b performs a slide-out operation in which the sub-screens are slid out of the display screen of the display unit 103 and the main screen G1 is displayed again (S3).

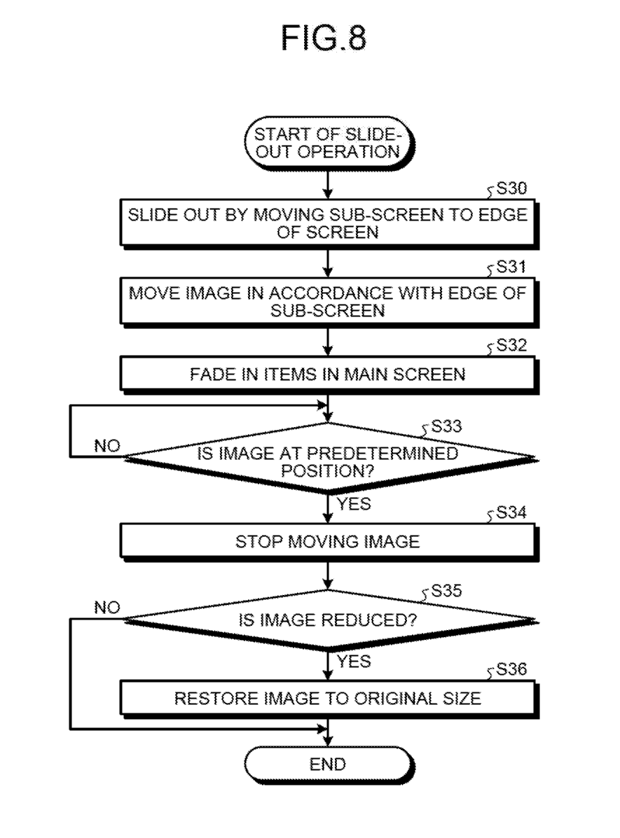

FIG. 8 is a flowchart for explaining an example of the slide-out operation. As illustrated in FIG. 8, after the start of operations, the screen display unit 104b slides out the sub-screens, which are displayed on the display unit 103, by moving them to an edge of the screen (S30).

At that time, the screen display unit 104b moves the image G20 in accordance with the edges of the sub-screens being slid gut (S31). Moreover, the screen display unit 104b performs a fade-in operation in which the items G11 to G16 are gradually displayed (by raising the brightness, for example) in the main screen G1 (S32). In the fade-in operation of the items G11 to G16, the selection content according to the specification of options is displayed at the corresponding items.

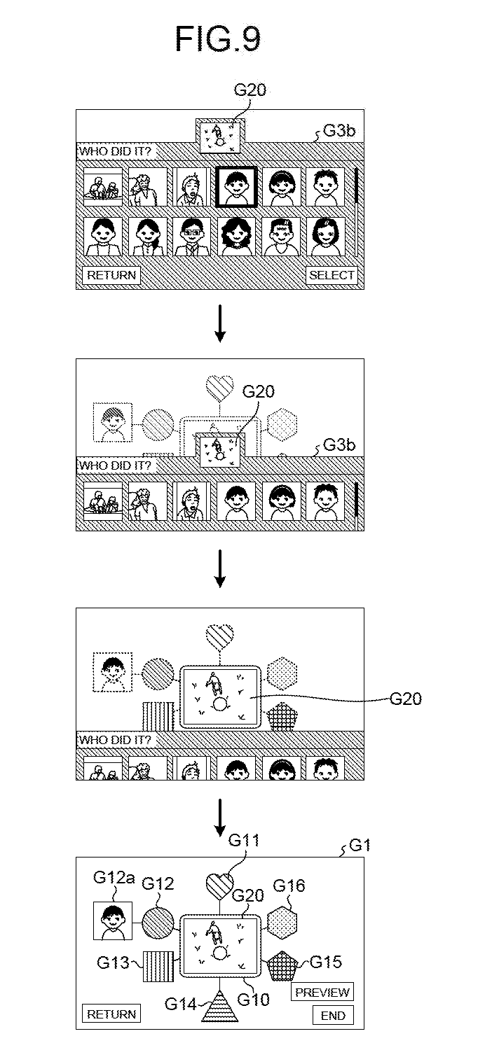

FIG. 9 is an explanatory diagram for explaining a slide-out operation with respect to the sub-screen G3b. As illustrated in FIG. 9, in the slide-out operation with respect to the sub-screen G3b, an animation display is performed in which the sub-screen G3b gradually moves toward an edge of the screen (the lower part of the screen). At that time, the image G20 is displayed on a continuing basis. Moreover, the items G11 to G16 in the main screen G1 are faded in for display. At that time, a selection content G12a specified as the option in the sub-screen G3b is displayed at the corresponding item G12.

Then, the screen display unit 104b determines whether or not the movement of the image G20 in accordance with the sliding out of the sub-screen has led the image G20 to a predetermined position (the position corresponding to the main subject display area G10) in the main screen G1 (S33). If the image G20 has not moved to the predetermined position (NO at S33), the screen display unit 104b keeps on moving the image G20.

When the image G20 moves to the predetermined position (YES at S33), the screen display unit 104b stops moving the image G20 in accordance with the sub-screen that is sliding out (S34).

Subsequently, the screen display unit 104b determines whether or not the image G20 in the sub-screens is reduced in size (S35). More particularly, the screen display unit 104b compares the display size of the image G20 in the main screen G1 with the display size of the image G20 in the sub-screens, and determines whether or not the image G20 in the sub-screens is reduced in size. When the image G20 is reduced in size (YES at S35), the screen display unit 104b restores the display size of the image G20 to the original size (i.e., the display size in the main screen G1) (S36). When the image G20 is not reduced in size (NO at S35), the screen display unit 104b ends the operations while keeping the same display size because of no change in the size of the image G20 in the sub-screens.

As a result of the slide-out operation, as illustrated in FIG. 9, the display on the display unit 103 is switched back from the sub-screen G3b to the main screen G1. At that time, the image G20 representing the main subject of the essay is displayed on a continuing basis on the display unit 103. As a result, the student terminal 10 prevents the user from forgetting about the image G20 representing the main subject of the essay. Hence, the student terminal 10 can support the user to continuously think about one particular affair (main subject).

Meanwhile, the screen display unit 104b can display a line that joins the image G20 with the selection frame of the option selected corresponding to the image G20 in the sub-screen, and can perform a display indicating the association with the image G20. Moreover, at the time of sliding out the sub-screen, the screen display unit 104b can continue with the display indicating the abovementioned association.

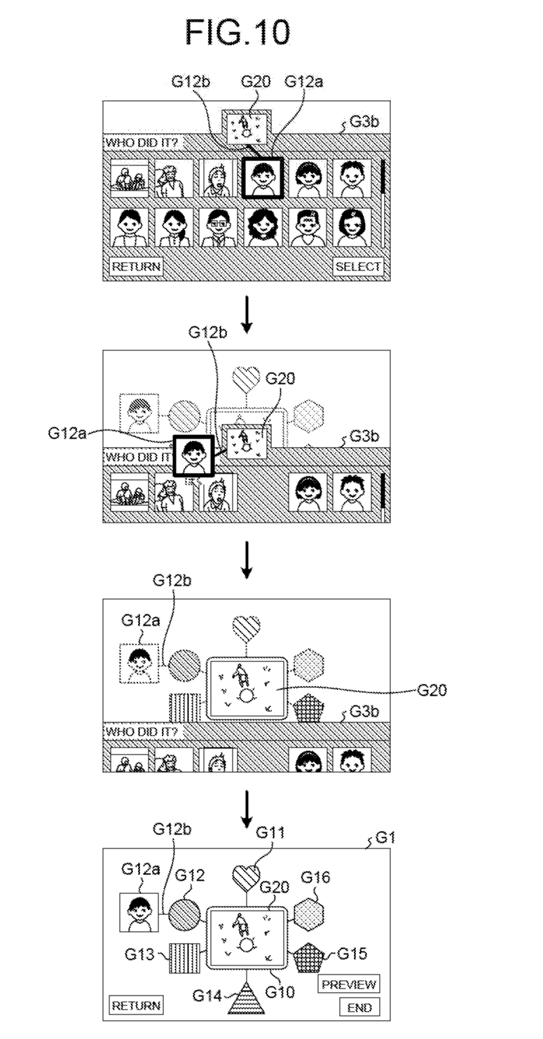

FIG. 10 is an explanatory diagram for explaining the sliding out of the sub-screen G3b. As illustrated in FIG. 10, the screen display unit 104b displays a link display G12b that links the image G20 with the selection content G12a selected corresponding to the image G20 in the sub-screen. Then, at the time of sliding out the sub-screen G3b, the screen display unit 104b moves the selection content G12a to a predetermined position in the main screen G1 and at the same time displays the link display G12b on a continuing basis. That enables the user to easily understand the association between the image G20 and the selection content G12a.

Returning to the explanation with reference to FIG. 3, the explanation is given about the operations subsequent to S9. After the operation performed at S9, the input operation receiving unit 104a determines, based oh an operation instruction from the operating unit 102, whether or not to display a preview of the essay in which the image G20 and the items G11 to G16 are input (S10). In the case of no preview (NO at S10), the system control proceeds to S12.

In the case of displaying a preview (YES at S10), the screen display unit 104b performs a display operation to display, on the display unit 103, a preview screen for displaying a preview of the essay based on the image G20 and the items G11 to G16 that are already input (S11).

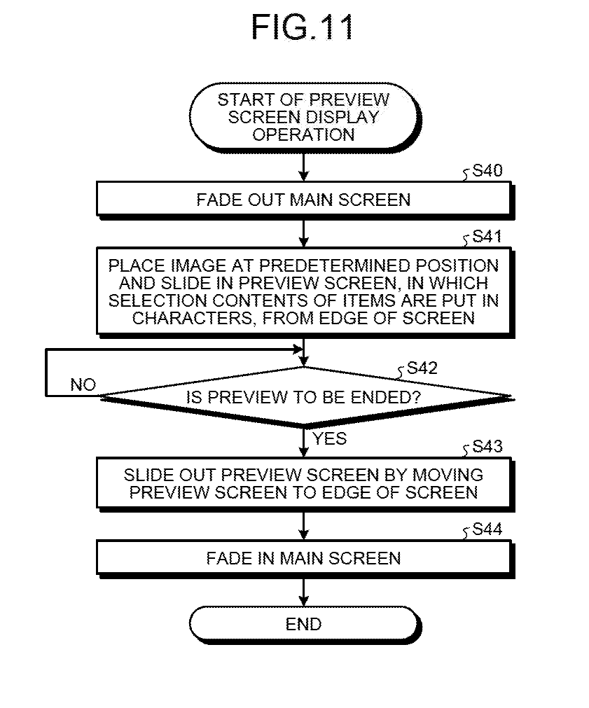

FIG. 11 is a flowchart for explaining an example of a preview screen display operation. As illustrated in FIG. 11, after the start of the operations for displaying a preview, the screen display unit 104b fades out the main screen G1 (S40). Then, the control unit 104 places the image G20 at a predetermined position and slides in a preview image, in which the selection contents of the items G11 to G16 are put in characters by referring to the item setting table 105c, from an edge of the screen (S41).

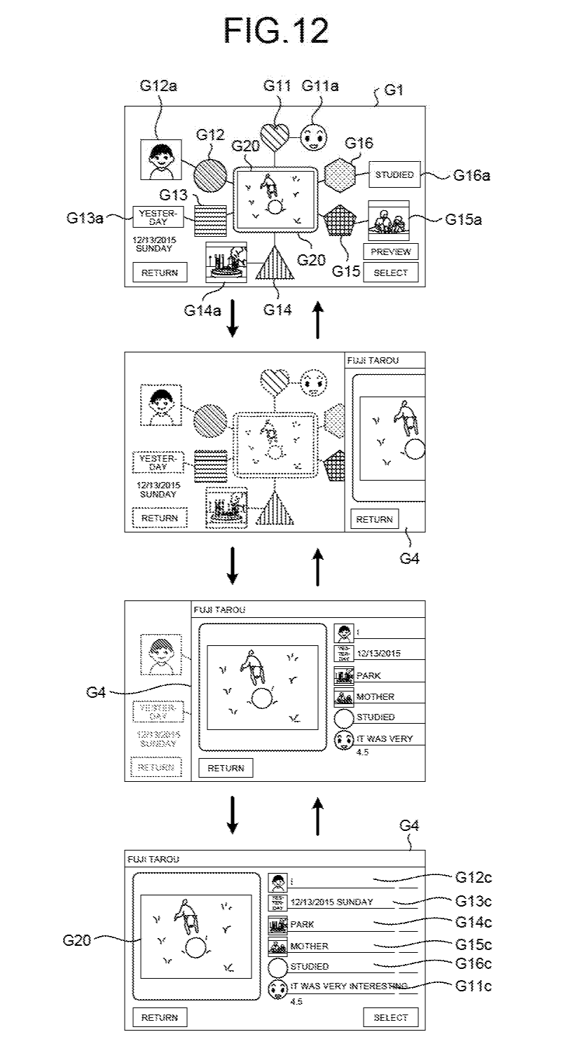

FIG. 12 is an explanatory diagram for explaining the display of a preview screen G4. Herein, it is assumed that selection contents G11a to G16a are already input in the items G11 to G16, respectively, in the main screen G1. As illustrated from the upper display .example to the lower display example in FIG. 12, the main screen G1 fades out as the preview starts. Then, the preview screen G4 slides in from an edge of the screen (in FIG. 12, from the right side of the screen). Meanwhile, the fading in of the preview screen G4 in FIG. 12 is only exemplary, and the preview screen G4 can alternatively be faded in from below the screen.

In the preview screen G4, the image G20 is displayed along with content details G11c to G16c corresponding to the selection contents G11a to G16a in the items G11 to G16, respectively. As a result, in the main screen G1, the user can confirm the details of the essay being created.

Subsequently, based on an operation instruction from the operating unit 102, the input operation receiving unit 104a determines whether or not to end the preview (S42). If the preview is not to be ended (NO at S42), then the control unit 104 waits for the operation and continues to display the preview image G4.

In the case of ending the preview (YES at S42), the screen display unit 104b slides out the preview screen G4 from the screen by moving it to an edge of the screen of the display unit 103 (S43) and fades in the main screen G1 (S44).

More particularly, as displayed from the lower display example to the upper display example in FIG. 12, when the preview ends, the preview screen G4 slides out to an edge of the screen (in FIG. 12, to the right side of the screen). Moreover, the main screen G1 is faded in and displayed.

Returning to the explanation with reference to FIG. 3, the explanation is given about the operations subsequent to S11. After the operation performed at S11, based on an operation instruction from the operating unit 102, the input operation receiving unit 104a determines whether or not to end the essay creation (S12). If the essay creation is not to be ended (NO at S12), then the system control returns to S5 and the control unit 104 continues with the essay creation. If the essay creation is to be ended (YES at S12), then the control unit 104 generates the creation data 105d based on the image G20 and the items G11 to G16 which are already input, and stores the creation data 105d (S13). It marks the end of the operations.

As described above, the student terminal 10 displays the image G20 regarding the affair to be included in the essay and displays the main screen G1 including the items G11 to G16 related to the image G20, and receives instruction operations with respect to the items G11 to G16. Then, in the student terminal 10, with respect to the screen in which the main screen G1 is feeing displayed, the sub-screens G3a to G3f, which represent a plurality of options subjectable to selection input for the item for which an instruction operation is received, are slid in and displayed. Moreover, in the student terminal 10, the image G20 displayed in the main screen G1 is displayed on the screen on a continuing basis during the sliding in of the sub-screens as well as after the completion of the sliding in of the sub-screens.

Furthermore, in the student terminal 10, registration of the image G20 is received in the photograph selection screen G2 and the registered image G20 is displayed at a predetermined position in the main screen G1. Moreover, in the student terminal 10, a plurality of items G11 to G16 related to the image G20 are displayed around the image G20. Then, in the student terminal 10, in response to the selection of one of the items G11 to G16, when the options regarding the selected item are to be displayed, the image G20 is moved to a position of keeping clear of the display positions of the options.

Thus, in the student terminal 10, since one particular affair (the image G20) is displayed on a continuing basis; it becomes possible to support the user to continuously think about that one particular affair (the image S20).

Meanwhile, in the present embodiment, the explanation is given for an example of essay creation support in which a single image is treated as the main subject, and an essay is created by setting items with respect to that main subject. However, alternatively, the functions of the input operation receiving unit 104a and the screen display unit 104b can be implemented in various case examples in which items are set (input) with respect to a single main subject. As a result, the functions of the input operation receiving unit 104a and the screen display unit 104b can be implemented in providing input support to a mind map (registered trademark) in which the main topic is placed at the center and items related to the main topic expand in a radial manner across multiple levels.

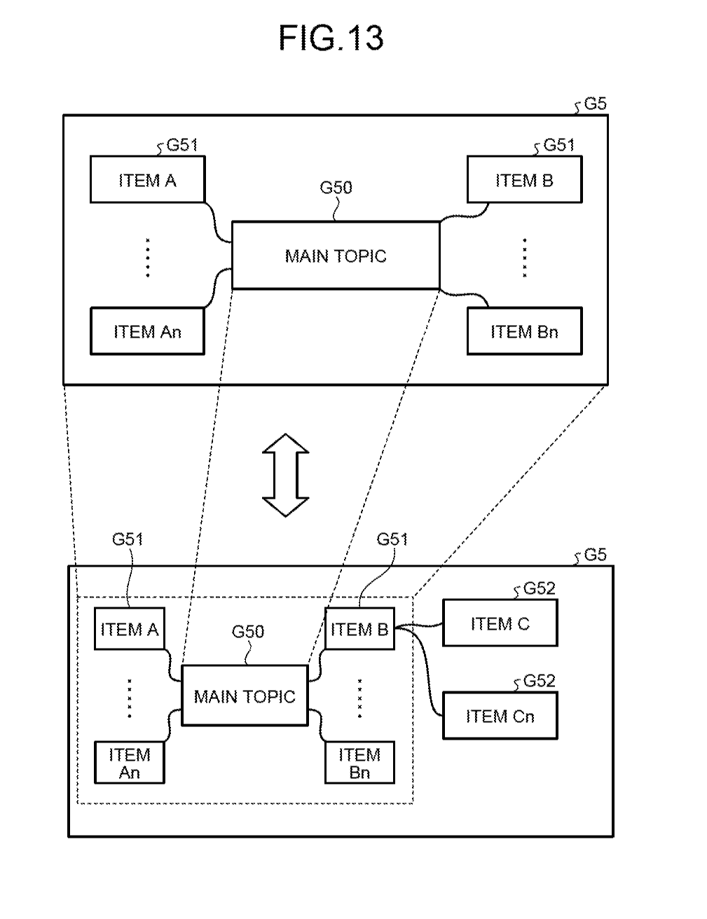

FIG. 13 is an explanatory diagram for explaining a modification example of providing the input support. As illustrated in FIG. 13, the screen display unit 104b displays an editing screen G5 in which a main topic G50 is placed in the center and a plurality of items G51 related to the main topic G50 is placed around the main topic G50. Then, in the case of inputting items G52 that are of a lower order than an “item B” representing one of the items G51, the screen display unit 104b gradually reduces the display area of the main topic G50 and the item G51, and moves that display to a position of keeping clear of the items G52. As a result of such application in the display of the editing screen G5, while providing input support to a mind map, the user can be supported to continuously think about one particular affair (the main topic G50).

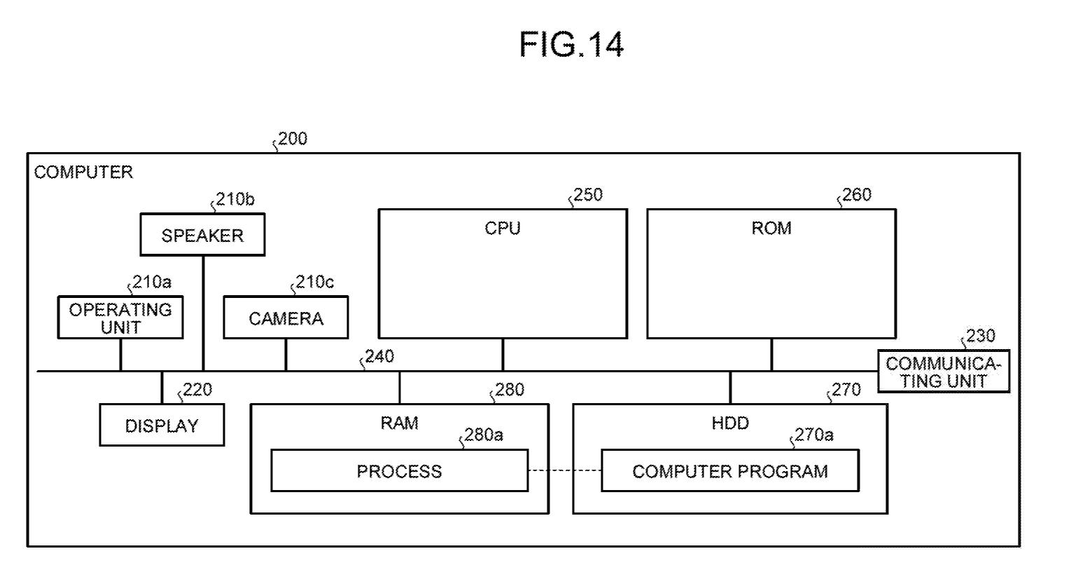

Meanwhile, the various operations explained above in the embodiment can be performed by executing pre-provided computer programs in a computer such as a personal computer or a workstation. Thus, explained below with reference to FIG. 14 is an exemplary computer that executes computer programs (an essay creation supporting program and an input supporting program) having the same functions as those described in the embodiment.

FIG. 14 is an explanatory diagram for explaining an example of a computer 200 that executes a computer-program 270a. As illustrated in FIG. 14, the computer 200 includes an operating unit 210a, a speaker 210b, a camera 210c, a display 220, and a communicating unit 230. Moreover, the computer 200 includes a central processing unit (CPU) 250, a read only memory (ROM) 260, a hard disk drive (HDD) 270, and a random access memory (RAM) 280. The constituent elements 210 to 280 are connected to each other by a bus 240.

The HDD 270 is used to store in advance the computer program 270a that implements the functions identical to the input operation receiving unit 104a and the screen display unit 104b according to the embodiment. Regarding the computer program 270a, integration and separation can be done in an identical manner to the constituent elements of the input operation receiving unit 104a and the screen display unit 104b. Meanwhile, not all of the data stored in the HDD 270 needs to be stored in the HDD 270. That is, as long as the data used in operations is stored in the HDD 270, it serves the purpose.

The CPU 250 reads the computer program 270a from the HDD 270 and loads it in the RAM 280. As a result, the computer program 270a functions as a process 280a. This process 280a expands a variety of data read from the HDD 270 in an area in the RAM 280 assigned to the process 280a, and performs various operations based on a variety of expanded data. Moreover, the process 280a includes operations performed by the input operation receiving unit 104a and the screen display unit 104b. Meanwhile, all operating units that are virtually implemented in the CPU 250 need not perform operations in the CPU 250, and only the operating units used in operations can be virtually implemented.

The computer program 270a need not to be stored in the HDD 270 or the ROM 260 from the beginning. Alternatively, for example, the computer program 270a can be stored in a portable physical medium such as flexible disk (FD), a compact disk read only memory (CD-ROM), a digital versatile disk (DVD), a magneto optical disk, or an IC card that can be inserted in the computer 200. Then, the computer 200 can obtain the computer program 270a from the portable physical medium and execute it. Alternatively, the computer program 270a can be stored in another computer or a server device that is connected to the computer 200 via a public line, the Internet, a local area network (LAN), or a wide area network (WAN). Thus, the computer 200 can obtain the computer program 270a from the other computer or the server device, and execute it.

According to an aspect of the present invention, it becomes possible to support continuous thinking about one particular affair.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein, an essay creation supporting program that causes a computer to execute a process comprising:
displaying a first screen that includes an object related to one particular affair serving as an essay target and includes a predetermined item related to the one particular affair;
receiving, in the first screen being displayed, an instruction operation regarding the predetermined item; and
displaying that includes
sliding in a second screen, in which a plurality of options regarding a predetermined item corresponding to the received instruction operation is indicated in a selection-input-receivable manner, for display in a screen in which the first screen is displayed, and
displaying, on a continuing basis on the screen, the object, which is displayed in the first screen, even during the sliding in and after completion of the sliding in.

2. The computer-readable recording medium according to claim 1, wherein the essay creation supporting program causes the computer to execute a process comprising:
receiving, in the second screen after completion of the sliding in, selection input of an option regarding the predetermined item; and
displaying that includes
sliding out, after receiving selection input in the second screen, the second screen for displaying the first screen, and
displaying, on a continuing basis on the screen, the object even during the sliding out.

3. The computer-readable recording medium according to claim 2, wherein the displaying on a continuing basis on the screen represents an animation display in which, during the sliding in and the sliding out of the second screen with respect to the first screen, the object is moved between placement position of the object in the first screen and placement position of the object in the screen during display of the second screen while changing position or size of the object in the screen.

4. The computer-readable recording medium according to claim 2, wherein the essay creation supporting program causes the computer to execute a process comprising:
performing display, when selection input with respect to one of options is received, indicating that the selected option and the object in the screen are associated; and
displaying that includes
displaying on a continuing basis on the screen, at time of displaying the first screen, by sliding out the second screen, the object along with display indicating that the selected option and the object are associated, and
displaying, in display state of the first screen, concerned option at position indicating the predetermined item in the first screen.

5. The computer-readable recording medium according to claim 1, wherein the essay is a daybook and the predetermined item is at least one of person, time, place, and feeling included in the daybook.

6. The computer-readable recording medium according to claim 1, wherein the object is a single photograph selected from among a plurality of photographs.

7. The computer-readable recording medium according to claim 1, wherein the essay creation supporting program causes the computer to execute a process comprising:
sliding in, when a predetermined operation is received in the first screen, a third screen, which includes the object and in which details of the predetermined item for which selection is received in the second screen are expressed in characters, for display in the first screen.

8. A computer-readable recording medium having stored therein an input supporting program that causes a computer to execute a process comprising:
receiving registration of an image;
displaying that includes
displaying the registered image at a predetermined position, and
displaying a plurality of input items related to the image around the image; and
motion-displaying that, in response to selection of an input item from among the plurality of input items, in case of displaying option of an input entry corresponding to the selected input item, includes moving the image from the predetermined position to a position of keeping clear of display position of the option of the input entry.

9. The computer-readable recording medium according to claim 8, wherein the input supporting program further causes the computer to execute a process comprising:
motion-displaying that, in response to selection of a single input entry from among options of the input entry, in case of again displaying the registered image and a plurality of input items related to the image around the image, includes moving the image from position of keeping clear of display position of the option of the input entry to the predetermined position.

10. The computer-readable recording medium according to claim 8, wherein the image is reduced in image size either during the motion-displaying, or at start of the motion-displaying, or after completion of the motion-displaying.

11. The computer-readable recording medium according to claim 8, wherein the image is maintained in image size before and after the motion-displaying.

12. The computer-readable recording medium according to claim 8, wherein the motion-displaying includes moving the image to upper side than placement position of the input item.

13. The computer-readable recording medium according to claim 8, wherein the image is either a still image or a moving image.

14. An information processing apparatus comprising a processor that executes a process comprising:
displaying a first screen that includes an object related to one particular affair serving as an essay target and includes a predetermined item related to the one particular affair;
receiving, in the first screen being displayed, an instruction operation regarding the predetermined item; and
displaying that includes
sliding in a second screen, in which a plurality of options regarding a predetermined item corresponding to the received instruction operation is indicated in a selection-input-receivable manner, for display in a screen in which the first screen is displayed, and
displaying, on a continuing basis on the screen, the object, which is displayed in the first screen, even during the sliding in and after completion of the sliding in.

15. The information processing apparatus according to claim 14, wherein the process further comprises:
receiving, in the second screen after completion of the sliding in, selection input of an option regarding the predetermined item; and
displaying that includes
sliding out, after receiving selection input in the second screen, the second screen for displaying the first screen, and
displaying, on a continuing basis on the screen, the object even during the sliding out.

16. The information processing apparatus according to claim 15, wherein the displaying on a continuing basis on the screen represents an animation display in which, during the sliding in and the sliding out of the second screen with respect to the first screen, the object is moved between placement position of the object in the first screen and placement position of the object in the screen during display of the second screen while changing position or size of the object in the screen.

17. The information processing apparatus according to claim 15, wherein the process further comprises:
performing display, when selection input with respect to one of options is received, indicating that the selected option and the object in the screen are associated; and
displaying that includes
displaying on a continuing basis on the screen, at time of displaying the first screen by sliding out the second screen, the object along with display indicating that the selected option and the object are associated, and
displaying, in display state of the first screen, concerned option at position indicating the predetermined item in the first screen.

18. The information processing apparatus according to claim 14, wherein the essay is a daybook and the predetermined item is at least one of person, time, place, and feeling included in the daybook.

19. The information processing apparatus according to claim 14, wherein the object is a single photograph selected from among a plurality of photographs.

20. The information processing apparatus according to claim 14, wherein the process further comprises:
sliding in, when a predetermined operation is received in the first screen, a third screen, which includes the object and in which details of the predetermined item for which selection is received in the second screen are expressed in characters, for display in the first screen.

21. An information processing apparatus comprising a processor that executes a process comprising:
receiving registration of an image;
displaying that includes
displaying the registered image at a predetermined position, and
displaying a plurality of input items related to the image around the image; and
motion-displaying that, in response to selection of an input item from among the plurality of input items, in case of displaying option of an input entry corresponding to the selected input item, includes moving the image from the predetermined position to a position of keeping clear of display position of the option of the input entry.

22. The information processing apparatus according to claim 21, wherein the process further comprises:
motion-displaying that, in response to selection of a single input entry from among options of the input entry, in case of again displaying the registered image and a plurality of input items related to the image around the image, includes moving the image from position of keeping clear of display position of the option of the input entry to the predetermined position.

23. The information processing apparatus according to claim 21, wherein the image is reduced in image size either during the motion-displaying, or at start of the motion-displaying, or after completion of the motion-displaying.

24. The information processing apparatus according to claim 21, wherein the image is maintained in image size before and after the motion-displaying.

25. The information processing apparatus according to claim 21, wherein the motion-displaying includes moving the image to upper side than placement position of the input item.

26. The information processing apparatus according to claim 21, wherein the image is either a still image or a moving image.
